(19) United States
(12) Patent Application Publication
(10) Pub. No.: US 2006/0241007 A1
(43) Pub. Date: Oct. 26, 2006

(54) Pack-A-Pouf

(76) Inventor: Colleen Kelly, Export, PA (US)

Correspondence Address: JAMES RAY & ASSOCIATES, 2640 PITCAIRN ROAD, MONROEVILLE, PA, 15146, US

(21) Appl. No.: 11/113,609

(22) Filed: Apr. 25, 2005

(51) Int. Cl. C11D 17/00

(52) U.S. Cl. 510/438

(57) ABSTRACT

A disposable apparatus for body cleansing comprising a preselected polymer type material, which exhibits flexibility, softness and porous properties, formed into a predetermined shape and a cleansing material deposited on such preselected polymer type material.

### CROSS REFERENCE TO RELATED APPLICATIONS

This application is closely related to U.S. patent application Ser. No. 11/018,461 entitled Pack-A-Poof, filed Dec. 21, 2004 and U.S. patent application Ser. No. ______, also entitled Pack-A-Poof, filed concurrently herewith.

### FIELD OF THE INVENTION

The present invention relates, in general, to a cleansing apparatus and, more particularly, the present invention relates to a disposable cleansing apparatus made of a polymer netting which includes a liquid or gel type soaps disposed thereon.

### BACKGROUND OF THE INVENTION

In recent years, there has been a major change in shower products. The puff (or “poof”) has been used as a cleansing agent as a shower tool for many consumers. When used in combination with a shower gel/soap it has become an indispensable tool because of the advantages it possesses over traditional wash cloth/bar soaps. The puff provides a way of washing with less mess in the shower. It also provides gentle exfoliation and produces a greater amount of soapsuds using a lesser amount of soap product than traditional cloths/bar soaps. However, the puff does have drawbacks. First and foremost, it does not travel well. When it is packed with a bottle of shower gel, it becomes rather bulky. Further, the puff becomes saturated with water during use and, thus, it must be placed in a plastic bag after use before being packed in the suitcase. Being wet, it can also be a breeding ground for bacteria. Another alternative is to simply discard the puff; however, with presently available puffs this may not be economically feasible. Thus, there is a need for an improved puff or poof, which can eliminate the drawbacks found with present poofs.

### SUMMARY OF THE INVENTION

In a first aspect the present invention provides a disposable apparatus for body cleansing comprising a preselected polymer type material, which exhibits flexibility, softness and porous properties, formed into a predetermined shape. Further the disposable apparatus includes a cleansing material deposited on the preselected polymer type material.

In another aspect of the invention there is provided a disposable package for body cleansing. The disposable package includes a preselected polymer type material, which exhibits flexibility, softness and porous properties, formed into a predetermined shape. There is a cleansing material selected from the group consisting of a liquid soap, a shower gel and combinations thereof deposited on such polymer type material and a container is provided for containing the disposable apparatus for body cleansing.

In yet another embodiment of the invention there is provided a disposable apparatus for surgical cleansing comprising a preselected polymer type material, which exhibits flexibility, softness and porous properties, formed into a predetermined shape and a cleansing material selected from the group consisting of a liquid medicated soap, a medicated gel and a combination thereof deposited on said polymer type material.

### OBJECTS OF THE INVENTION

It is, therefore, one of the primary objects of the present invention to provide a disposable “poof” which has deposited thereon a liquid soap or shower gel.

Another object of the present invention is to provide a disposable poof with a liquid soap or shower gel dried thereon wherein the soap or gel is capable of being reconstituted upon the application of water thereto to form soapsuds.

It is another object of the present invention to provide a disposable poof with a liquid soap or gel deposited thereon and a packaging means for enclosing the poof.

Yet, another object of the present invention is to provide a disposable poof, which uses a polymer netting which is relatively inexpensive.

Still another object of the present invention is to provide a disposable poof, which is convenient and travel-sized.

Another object of the present invention is to provide a disposable poof, which is smaller than traditional poofs.

It is still another object of the present invention to provide a disposable cleansing apparatus, which contains medicinal soap or gel for surgical cleansing.

In addition to the various objects and advantages of the invention which have been described in some specific detail above it should be noted that various other objects and advantages of the present invention will become more readily apparent to those persons who are skilled in the relevant art from the following more detailed description, particularly, when such description is taken in conjunction with the attached drawing Figures and with the appended claims.

### BRIEF DESCRIPTION OF THE DRAWINGS

FIG. 1 is a partial perspective view of the disposable apparatus according to an embodiment of the invention packed in a container.

FIG. 2 is a partial perspective view of the disposable apparatus showing the shower gel or liquid soap deposited thereon.

FIG. 3 is a partial perspective view of the disposable apparatus showing the thread used for securing the net like material.

### BRIEF DESCRIPTION OF THE PRESENTLY PREFERRED AND VARIOUS ALTERNATIVE EMBODIMENTS OF THE INVENTION

Prior to proceeding to the more detailed description of the invention, it should be noted that identical components having identical functions have been designated with identical reference numerals throughout the several views illustrated in the drawings for the sake of clarity.

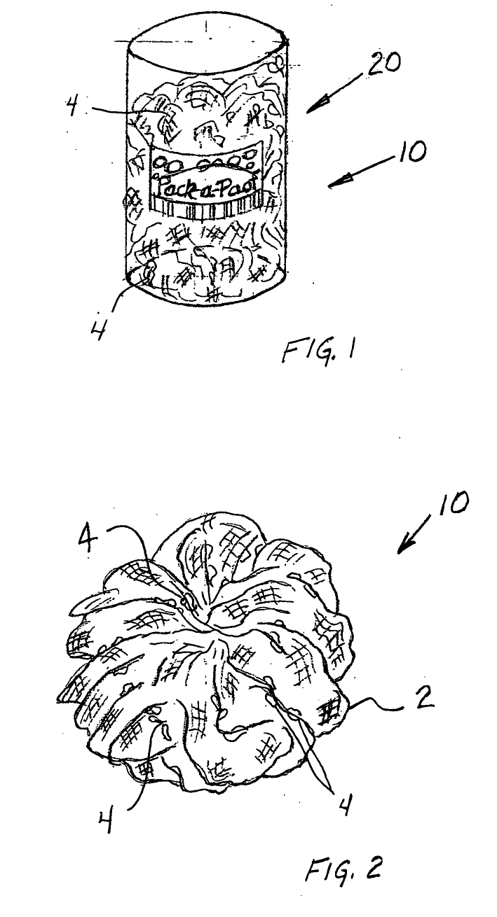

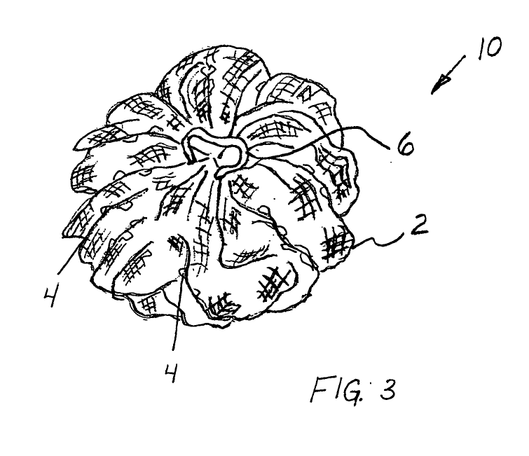

Now reference is made, more particularly, to drawing FIGS. 2 and 3. Illustrated therein is a disposable apparatus called a poof, generally designated 10, for body cleansing. Traditional poofs 10 or puffs are used to cleanse the body, and provide the benefits of gentle exfoliation and robust soapsuds.

The poofs 10 provide a distinct advantage over washing with conventional bar soaps and washcloths or even with shower gels. Pouring a shower gel directly into ones hand isn't effective and sliding off the hand loses much of the gel.

The “poof” 10 of the present invention is a sponge like object constructed of a flexible material 2. It is preferred that such flexible material is a net like material and even more preferred that such net like material is a polymer netting 2. Such poof 10 contains a plurality of layers of such polymer netting 2 bunched together in a predetermined shape to form such poof 10. There is further a means 6 engageable with such poof 10 for securing such plurality of layers of the net like material 2. It is presently preferred that such means for securing the net like material 2 be one of thread 6 as is seen in FIG. 4. Such thread 6 is tied together. It is also presently preferred that the predetermined shape of the poof 10 is substantially spherical. The poof 10 includes a coating 4 of shower gel or a liquid soap deposited on the flexible material 2. The liquid soap or gel 4 may be dried onto the flexible material 2 and thus be capable of being reconstituted upon the application of a liquid, such as water, thereto to form the soapsuds. Alternatively, as shown in FIG. 1, the liquid soap or shower gel 4 can remain moist and the poof 10 can be placed within a packaging means 20, such as a plastic, foil, or water-proofed treated paper bag to contain the poof 10 and soap 4 therein. It is presently preferred that such disposable package 20 is a plastic bag, however any other well known bag material may be used such as water-resistant treated paper, foil, and the like. Thus, the poof 10 contains all that is necessary for cleansing in a shower or bath.

As shown in FIG. 2, the soap or gel 4 can be disposed on the outer portion of the poof, within the inner portion of the poof or on both the inner and outer portion of the poof.

Yet in another embodiment of the invention there is provided a disposable cleansing apparatus 10 similar to the poof 10 described previously except this embodiment is designed for use in surgical scrubbing. The basic difference in this cleansing apparatus 10 is that the cleansing material 4 comprises a medicated liquid soap or a medicated gel for such surgical cleansing. It should be noted that such medicated liquid soap and medicated gel includes anti-microbial, anti-bacterial, povidone-iodine (betadine), antiseptic, surgical soap, and sterilizing soap.

Thus, the present invention provides a disposable poof 10 with a shower gel or liquid soap 4 deposited thereon for use as a cleansing agent and then is thrown away. Such disposable poof 10 is carried in a plastic bag 20, which is also disposable. Since the poof 10 is disposable the problem with packing a wet poof is eliminated since the poof 10 is just discarded after use. Also the danger of the wet stored poof being a breeding ground for bacteria is also eliminated since there is no storage of wet poofs 10.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. A disposable apparatus for body cleansing, said disposable apparatus comprising:
(a) a preselected polymer type material, which exhibits flexibility, softness and porous properties, formed into a predetermined shape; and
(b) a cleansing material deposited on said preselected polymer type material.

2. A disposable apparatus for body cleansing as recited in claim 1, wherein said preselected polymer type material is a plurality of layers of material bunched together into said predetermined shape to form a poof and said disposable apparatus further includes a means engageable with said plurality of layers of material for securing them together and said cleansing material is selected from the group consisting of liquid soap, shower gel and combinations thereof.

3. A disposable apparatus for body cleansing as recited in claim 2, wherein one of said liquid soap, said shower gel and said combination thereof is dried on said preselected polymer type material and is capable of being reconstituted upon an application of water thereto.

4. A disposable apparatus for body cleansing as recited in claim 2, wherein one of said liquid soap, said shower gel and said combination thereof is deposited on said polymer type material and said apparatus further includes a packaging means for enclosing said poof therein.

5. A disposable apparatus for body cleansing as recited in claim 4, wherein said packaging means includes one of a plastic, foil, treated paper bag and combinations thereof.

6. A disposable apparatus for body cleansing as recited in claim 1, wherein said polymer type material is a flexible netting material.

7. A disposable apparatus for body cleansing as recited in claim 6, wherein said flexible netting material is an organic polymer netting.

8. A disposable apparatus for body cleansing as recited in claim 2, wherein said means for securing said plurality of layers of said polymer type material in said form of said poof is thread.

9. A disposable apparatus for body cleansing as recited in claim 8, wherein said thread is a synthetic fabric.

10. A disposable apparatus for body cleansing as recited in claim 9, wherein said synthetic fabric is nylon.

11. A disposable apparatus for body cleansing as recited in claim 2, wherein said cleansing material is deposited on said polymer type material which is positioned on an outside of said poof.

12. A disposable apparatus for body cleansing as recited in claim 2, wherein said cleansing material is deposited on said polymer material within an inner portion of said poof.

13. A disposable apparatus for body cleansing as recited in claim 2, wherein said cleansing material is deposited on said polymer type material on both an outer portion and within an inner portion of said poof.

14. A disposable package for body cleansing, said disposable package comprising:
(a) a disposable apparatus for body cleansing, said disposable apparatus including:
(i) a preselected polymer type material, which exhibits flexibility, softness and porous properties, formed into a predetermined shape; and
(ii) a cleansing material selected from the group consisting of a liquid soap, a shower gel and combinations thereof deposited on said polymer type material material; and
(b) a container for containing said disposable apparatus for body cleansing.

15. A disposable package for body cleansing as recited in claim 14 wherein said preselected polymer type material is a plurality of layers of material bunched together into said predetermined shape to form a poof and said disposable apparatus further includes a means engageable with said plurality of layers of flexible material for securing said plurality of layers together and said cleansing material is dried onto said polymer type material and is capable of being reconstituted upon the application of water thereto.

16. A disposable package for body cleansing as recited in claim 14, wherein said container is one of a plastic, treated paper and foil bag.

17. A disposable apparatus for surgical cleansing, said disposable apparatus comprising:
(a) a preselected polymer type material, which exhibits flexibility, softness and porous properties, formed into a predetermined shape; and
(b) a cleansing material selected from the group consisting of a liquid medicated soap, a medicated gel and a combination thereof deposited on said polymer type material.

18. A disposable apparatus for surgical cleansing as recited in claim 17, wherein said preselected polymer type material is a plurality of layers of material bunched together into said predetermined shape to form a poof and said disposable apparatus further includes a means engageable with said plurality of layers of polymer type material for securing said plurality of layers together and said liquid medicated soap and said medicated gel are selected from the group consisting of anti-microbial, anti-bacterial, povidone-iodine, antiseptic, surgical soap, and sterilizing soap.

19. A disposable apparatus for surgical cleansing as recited in claim 17 wherein one of said liquid medicated soap and said medicated gel is dried on said polymer type material and is capable of being reconstituted upon an application of water thereto.

20. A disposable apparatus for body cleansing as recited in claim 17 wherein one of said liquid medicated soap and said medicated gel is deposited on said polymer type material and said apparatus further includes a packaging means for enclosing said disposable apparatus therein.
